(19) United States
(12) Patent Application Publication
(10) Pub. No.: US 2005/0274160 A1
(43) Pub. Date: Dec. 15, 2005

(54) Method for the manufacture of a locally weakened leather covering

(75) Inventors: Henry Muller, Landshut (DE); Rudolf Aichner, Kirchberg (DE); Hubert Pirkl, Tiefenbach (DE)

Correspondence Address: SUGHRUE MION, PLLC, 2100 PENNSYLVANIA AVENUE, N.W., SUITE 800, WASHINGTON, DC, 20037, US

(73) Assignee: LISA DRAXLMAIER GMBH

(21) Appl. No.: 11/138,482

(22) Filed: May 27, 2005

(30) Foreign Application Priority Data
May 28, 2004 (DE) 10 2004 026 204.7

(51) Int. Cl. C14B 1/00

(52) U.S. Cl. 69/8

(57) ABSTRACT

The invention relates to a method for the manufacture of a casing covered at least partially with a leather covering, in particular for use in a vehicle, with a locally defined weakened area of the leather covering characterised in that, prior to the introduction of the leather covering's weakened area, at least the area into which the weakening is to be introduced is subjected to a drying treatment.

The invention relates to a method for the manufacture of a casing with leather covering, especially for use in a vehicle, which introduces a reduction in the thickness of the leather covering, which is limited locally.

### PRIOR ART

In vehicles, particularly of the executive class and luxury class, leather materials or leather-like materials are used to cover large areas of the vehicle's interior, especially the dashboard, storage compartments, storage compartment lids, armrests and the casings of airbags, to produce a high-quality visual appearance. In this case it is essential that the covering material has a thickness, which on the one hand guarantees that seams or joining lines of the covered casing do not show through and ensures on the other that there is sufficient resistance to mechanical impacts.

However, primarily in the area of airbag casings it must also be ensured that the covering material does not prevent the airbag from unfolding in the event of a collision. It is, therefore, advantageous to create the leather material so that it ruptures along previously defined tear lines and thus assists airbag casings to unfold in a preferably pre-defined direction.

Up to now tear lines of this type have been provided, for example, by means of specially formed seams in which the force necessary to tear them open could easily be adjusted via the amount of the stitching material as well as the design of the seam itself. However, these seams do not fulfill today's requirements on the visual appearance of casings.

Therefore, methods were developed to design weakened areas where the reverse side of the leather covering, that is, the side of the covering material facing the casing and facing away from the interior of the vehicle, underwent thinning that was limited locally. A method of this type is described for example in DE 199 44 371 A1 in which a tear line formed in a leather lining by weakening of the material is introduced by means of a diamond bur. Furthermore, in DE 100 55 546 A1 an airbag cladding with weakening structures is described in which the weakened area was introduced into the material in the shape of an undercut made by a cutting device.

However, it has turned out in practice that such weakened areas, where the aim is to cut into or remove the leather material to a residual thickness of approximately 0.2 to 0.8 mm, or even in a possibly produced initial area to only 0.2 mm-0.4 mm, begin to stand out shortly after completion of the casing covered with leather or a leather-like material. As a result the visual appearance of the casing is permanently spoilt.

### DESCRIPTION OF THE INVENTION

Therefore, it was an object of the invention to provide a method for the manufacture of casings with leather covering, particularly for use in vehicles, which does not have the problems known from the prior art.

The object of the invention is solved by a method with the features of claim 1. Advantageous embodiments of the invention are found in the dependent claims 2 to 12.

It was discovered that the weakened area showing through in the leather material depends noticeably on the moisture content of the covering material. It turned out surprisingly in this case that if the moisture content of at least the area of the leather covering where the weakened area is to be introduced is reduced, it is possible to achieve an enduringly advantageous visual appearance of the casing without the weakened area of the leather standing out.

It was thereby determined that the leather materials used have a moisture content of approximately 7 to 12% in the as-delivered condition and depending on the type of leather, for example aniline, nappa, embossed leather or similar. If this moisture content can be reduced at least in parts of the leather covering to preferably less than 5% prior to introduction of the weakened area, then it is possible to achieve an advantageous visual appearance of the casing without the processing properties of the leather material being restricted unfavourably.

In a preferred embodiment of the method according to the invention, reduction of the moisture takes place in a climatic chamber or in a drying oven. This provides a method which allows the processing of even large quantities of leather using equipment that is particularly easy to use and adjust.

In an alternatively preferred embodiment, reduction of the moisture takes place in an autoclave. In a further alternative embodiment of the method according to the invention, reduction of the moisture content takes place by applying a vacuum. In an especially preferred embodiment, the vacuum is thereby only applied to parts of the leather covering. As a result of this a method is provided with which partial reduction in particular of the moisture content is rendered possible with especially simple instruments in preferably clearly defined partial areas of the leather covering.

In a preferred embodiment of the method according to the invention, the leather covering is applied onto the casing substantially free from seams. This supports the visual appearance of the casing in a particularly advantageous manner. A seamless embodiment of the casing according to the invention is also guaranteed if in the areas of the lateral edges of the casing, thus for example on the circumference of a steering wheel or in the area of steering wheel spokes, joining seams are realised with a possibly back to back arrangement of the leather material.

In a further preferred embodiment of the method according to the invention, the introduction of the weakened area is brought about by cutting into the leather or leather-like material. In an especially preferred embodiment, cutting takes place in the form of an undercut, which is introduced on the side of the leather covering facing the casing.

In a particularly preferred embodiment of this method, the weakened area is introduced by means of a suitable cutting tool or milling cutter. This provides a method with which it is possible to set a preferably accurately definable thickness of the leather material in the weakened area using especially simple and easily controlled instruments.

In a further preferred embodiment of the method according to the invention, the thickness of the leather covering in the weakened area is approximately 0.2-0.8 mm. In an especially preferred embodiment of the invention, the weakened area additionally has at least one initial area for initiation of the tear where the thickness of the leather material is approximately 0.2-0.4 mm. In this way, especially when using the method according to the invention, a casing is obtained in which the leather covering does not work against unfolding of an airbag with any substantial forces and thus does not impede unfolding and in which a smooth visual appearance of the leather covering is guaranteed at the same time. As a rule the thickness of the weakened area depends in this case on the type and texture of the leather used.

According to a further preferred embodiment of the invention, the weakened area or areas of the leather covering define one or more tear lines along which the leather can tear open in a defined direction and manner.

In this case it can be advantageous if for initiation of the tear, which as is known requires increased force, a tear initiation area is disposed in the leather covering, for example by introducing a piercing preferably designed to run to a point. In an especially preferred manner, the weakened areas of the leather material are aligned thereby with the piercing, in particular with the corner areas of this piercing.

In a further preferred embodiment of the method according to the invention, the casing is disposed in the area of the airbag inside a steering wheel or in the area of the dashboard in front of the passenger seat.

### BRIEF DESCRIPTION OF THE DRAWING

The present invention will be explained in more detail on the basis of FIG. 1 whereby this figure merely represents one example of an embodiment of a casing produced using the method according to the invention. However, the figure is not suitable for limiting the general basic idea of the invention in any manner whatsoever.

FIG. 1 shows a perspective view of an airbag casing.

### WAYS TO CARRY OUT THE INVENTION

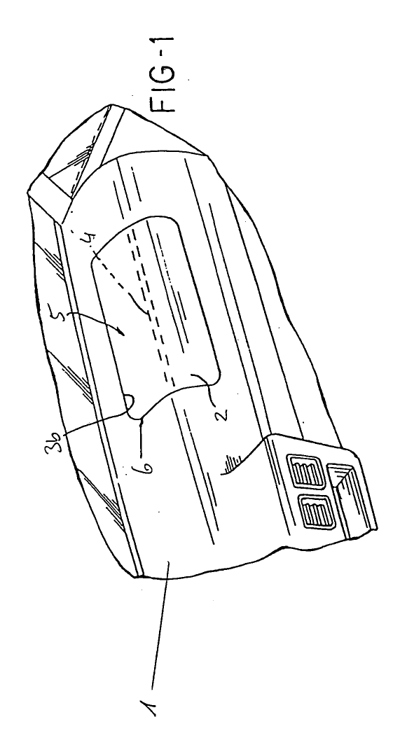

FIG. 1 represents a schematic perspective view of an airbag casing 1, in which a leather covering 2 has a weakened area 3a, b, which is disposed precisely above the flap area 4 and the peripheral edge 6 of casing 1. This weakened area 3a, b is introduced on the reverse of the leather covering in the form of an undercut by means of a cutting tool (not shown). On unfolding of the airbag disposed beneath the airbag flap, the leather covering 2 tears open along the weakened area 3a, b and thus advantageously supports unfolding of the airbag. At the same time the leather covering does not oppose the unfolding process with such forces that unfolding of the airbag would effectively be obstructed.

1. A method for the manufacture of a casing covered at least partially with a leather covering, in particular for use in a vehicle, with a locally defined weakened area of the leather covering, characterized in that, prior to the introduction of the leather covering's weakened area, at least the area into which the weakening is to be introduced is subjected to a drying treatment.

2. The method according to claim 1, characterized in that the area into which the weakening is to be introduced has a moisture content <5% before the weakened area is introduced.

3. The method according to claim 1, characterized in that reduction of the moisture, at least of the area into which the weakening is to be introduced, takes place in a climatic chamber or a drying oven.

4. The method according to claim 1, characterized in that reduction of the moisture, at least of the area into which the weakening is to be introduced, takes place in an autoclave.

5. The method according to claim 1, characterized in that reduction of the moisture, at least of the area into which the weakening is to be introduced, takes place preferably by partial application of a vacuum.

6. The method according to claim 1, characterized in that the leather covering is applied substantially seam-free of the casing.

7. The method according to claim 1, characterized in that the weakened area is produced by means of cutting in, preferably in the form of an undercut introduced on the side of the leather covering facing the casing.

8. The method according to claim 7, characterized in that the undercut is introduced by means of a cutting tool or a milling cutter.

9. The method according to claim 1, characterized in that the thickness of the leather covering is 0.2-0.8 mm in the weakened area.

10. The method according to claim 1, characterized in that the thickness of the leather covering is 0.2-0.4 mm in the region of one or more initial areas for tear initiation.

11. The method according to claim 1, characterized in that the weakened areas defines tear lines of the leather covering.

12. The method according to claim 1, characterized in that the casing covers the airbag in a steering wheel or a dashboard disposed in front of the passenger.
